(19) United States
(12) Patent Application Publication
(10) Pub. No.: US 2007/0208142 A1
(43) Pub. Date: Sep. 6, 2007

(54) FLUOROPOLYMER CURING COMPOSITIONS

(76) Inventors: Eric W. Adair, Hugo, MN (US); Werner M.A. Grootaert, Oakdale, MN (US); Steven G. Corveleyn, Knokke-Heist (BE)

Correspondence Address: 3M INNOVATIVE PROPERTIES COMPANY, PO BOX 33427, ST. PAUL, MN, 55133-3427, US

(21) Appl. No.: 11/276,533

(22) Filed: Mar. 3, 2006

(51) Int. Cl. C08F 214/18

(52) U.S. Cl. 525/326.2; 525/387

(57) ABSTRACT

Provided is a composition comprising a fluorocarbon polymer, a radical initiator, and a first and second curing co-agent. In one aspect, the first curing co-agent is represented by the formula CH₂═CH—R_{f}—CH═CH₂, wherein R_{f} is selected from a divalent perfluoroaliphatic group optionally containing one or more O atoms, a perfluoroarylene group, and a perfluoroalkarylene group. In another aspect, the first curing co-agent is selected from the group consisting of an allyl cyanurate, an allyl isocyanurate, a methallyl cyanurate, and a methallyl isocyanurate. In either aspect, the second curing co-agent is an organic compound including at least one terminal alkene, with the proviso that the second curing co-agent is not a member of the group of first curing co-agents. Also provided are the reaction product of these compositions and a method of making an elastomer comprising curing these compositions.

### TECHNICAL FIELD

This description relates to fluoropolymer curing compositions, cured articles, and methods for curing.

### BACKGROUND

Fluorinated and particularly perfluorinated elastomers have unique thermal and chemical resistance properties. Preparation of these elastomers from fluoropolymer precursors (sometimes referred to as “raw gums”), however, can be difficult. The fluoropolymer precursors and compositions containing the fluoropolymer precursors may be incompatible with processing and curing additives, such as, for instance, triallylisocyanurate (TAIC). In addition to incompatibility, TAIC is also disposed to undesirable homopolymerization, which can lead to processing difficulties in preparing fluorinated elastomers.

### SUMMARY

The compositions of the present invention may provide several processing advantages over similar compositions that contain cyanurate or isocyanurate curing co-agents as the only curing co-agents. For instance, rheological properties of the compositions of the present invention may be improved over compositions that use TAIC as the sole curing co-agent. The compositions described herein generally display longer t′50 and t′90 than those compositions that use TAIC as the sole curing co-agent. The values t′50 and t′90 measure the time for the torque of a sample to reach a value equal to M_{L}+0.50(M_{H}−M_{L}) and the time for the torque to reach M_{L}+0.90(M_{H}−M_{L}), respectively. M_{L} is the minimum torque and M_{H} is the highest torque attained during a specified period of time when no plateau or maximum torque is obtained. A longer t′50 or t′90 may indicate either a lower level of pre-curing of a composition, a lower level of homopolymerization of curing co-agent, or a combination thereof. By reducing the amount of TAIC added to the compositions, some of the embodiments of the present invention show marked decrease in pre-curing and homopolymerization of curing co-agent(s). Decreasing pre-curing and homopolymerization of curing co-agent(s) can improve the processability of fluorinated elastomers.

In one aspect, the present description relates to a composition comprising a fluorocarbon polymer, a radical initiator, and a first curing co-agent. The first curing co-agent is selected from the group consisting of an allyl cyanurate, an allyl isocyanurate, a methallyl cyanurate, and a methallyl isocyanurate. The composition further comprises a second curing co-agent comprising an organic compound including at least one terminal alkene, with the proviso that the second curing co-agent is not a member of the group of first curing co-agents. As used herein, terminal alkene refers to a compound that contains a C═CH₂ moiety.

In another aspect, the present description provides a composition comprising a fluorocarbon polymer, a radical initiator, and a first curing co-agent. In this aspect, the first curing co-agent is a fluorinated compound represented by the formula CH₂═CH—R_{f}—CH═CH₂. R_{f} is selected from a divalent perfluoroaliphatic group optionally containing one or more O atoms, a perfluoroarylene group, and a perfluoroalkarylene group. The composition further comprises a second curing co-agent comprising an organic compound including at least one terminal alkene, with the proviso that the second curing co-agent is not a member of the group of first curing co-agents.

In another aspect, the present description provides a method for forming an elastomer comprising curing a composition comprising a fluorocarbon polymer, a radical initiator, and a first curing co-agent. The first curing co-agent is selected from the group consisting of an allyl cyanurate, an allyl isocyanurate, a methallyl cyanurate, and a methallyl isocyanurate. The composition further comprises a second curing co-agent comprising an organic compound including at least one terminal alkene, with the proviso that the second curing co-agent is not a member of the group of first curing co-agents.

In yet another aspect, the present description provides an elastomer comprising the reaction product of a fluorocarbon polymer, a radical initiator, and a first curing co-agent. The first curing co-agent is selected from the group consisting of an allyl cyanurate, an allyl isocyanurate, a methallyl cyanurate, and a methallyl isocyanurate. The composition further comprises a second curing co-agent comprising an organic compound including at least one terminal alkene, with the proviso that the second curing co-agent is not a member of the group of first curing co-agents.

In another aspect, the present description provides a method for forming an elastomer comprising curing a composition comprising a fluorocarbon polymer, a radical initiator, and a first curing co-agent. In this aspect, the first curing co-agent is a fluorinated compound represented by the formula CH₂═CH—R_{f}—CH═CH₂. R_{f} is selected from a divalent perfluoroaliphatic group optionally containing one or more O atoms, a perfluoroarylene group, and a perfluoroalkarylene group. The composition further comprises a second curing co-agent comprising an organic compound including at least one terminal alkene, with the proviso that the second curing co-agent is not a member of the group of first curing co-agents.

In yet another aspect, the present description provides an elastomer comprising the reaction product of a fluorocarbon polymer, a radical initiator, and a first curing co-agent. In this aspect, the first curing co-agent is a fluorinated compound represented by the formula CH₂═CH—R_{f}—CH═CH₂. R_{f} is selected from a divalent perfluoroaliphatic group optionally containing one or more O atoms, a perfluoroarylene group, and a perfluoroalkarylene group. The composition further comprises a second curing co-agent comprising an organic compound including at least one terminal alkene, with the proviso that the second curing co-agent is not a member of the group of first curing co-agents.

Generally, compositions as described herein also provide a surprising advantage over those containing TAIC as the sole curing co-agent in that TAIC is prone to undesirable homopolymerization. Compositions wherein TAIC is the sole curing co-agent often give mold fouling, mold sticking, and surface bleeding. In contrast, compositions comprising a first curing co-agent selected from the group consisting of an allyl cyanurate, an allyl isocyanurate, a methallyl cyanurate, and a methallyl isocyanurate and a second curing co-agent comprising an organic compound including at least one terminal alkene, with the proviso that the second curing co-agent is not a member of the group of first curing co-agents, may display better mold release, and decreased mold fouling compared to compositions employing TAIC as the sole curing co-agent. Additionally, compositions comprising a first curing co-agent that is a fluorinated compound represented by the formula CH₂═CH—R_{f}—CH═CH₂, where R_{f} is selected from a divalent perfluoroaliphatic group optionally containing one or more O atoms, a perfluoroarylene group, and a perfluoroalkarylene group, and a second curing co-agent comprising an organic compound including at least one terminal alkene, with the proviso that the second curing co-agent is not a member of the group of first curing co-agents, also may display better mold release, and decreased mold fouling compared to compositions employing TAIC as the sole curing co-agent.

Furthermore, TAIC is not easily processable with the fluorocarbon polymers described herein. Particularly, TAIC is not easily incorporated using conventional processing methods. In contrast, the compositions described herein allow for easy incorporation of the curing co-agents into the fluorocarbon polymers described herein. This easy incorporation leads to more desirable processing.

In other embodiments it has surprisingly been found that when a composition according to the present description is cured, the compression set for an elastomer formed by curing the fluoropolymer is comparable to or better than an elastomer formed by curing a fluoropolymer having TAIC as the sole curing co-agent. Thus, the processing advantages described herein may be obtained without a significant change in the physical properties of the compositions or elastomeric products described herein.

The above summary is not intended to describe each disclosed embodiment or every implementation of the present invention. The detailed description and examples that follow, more particularly exemplify illustrative embodiments.

### DETAILED DESCRIPTION

In one aspect, the present description provides a composition comprising a first curing co-agent selected from the group of an allyl cyanurate, an allyl isocyanurate, a methallyl cyanurate, and a methallyl isocyanurate. In another aspect, the first curing co-agent is represented by the formula CH₂═CH—R_{f}—CH═CH₂, wherein R_{f} is selected from a divalent perfluoroaliphatic group optionally containing one or more O atoms, a perfluoroarylene group, and a perfluoroalkarylene group. In either aspect, the compositions further comprise a second curing co-agent comprising an organic compound including at least one terminal alkene, with the proviso that the second curing co-agent is not a member of the group of first curing co-agents. The compositions further comprise a fluorocarbon polymer and a radical initiator.

The compositions described herein, in some embodiments, show improved rheological properties compared to compositions obtained by the use, for instance, of triallylisocyanurate as the sole curing co-agent. Indeed, when triallylisocyanurate is used as the sole curing co-agent in combination with a first curing co-agent as described herein, the compositions generally display a longer t′50 and t′90 than those compositions that use triallylisocyanurate (TAIC) as the sole curing co-agent. The t′50 may be, for instance, 10% longer or more, 20% longer or more, 50% longer or more, even over 100% longer than compositions that a composition comprising the same fluorocarbon polymer and radical initiator but using TAIC as the sole curing co-agent. Similarly, the t′90 may be, for instance, 10% longer or more, 20% longer or more, 50% longer or more, even over 100% longer than compositions that a composition comprising the same fluorocarbon polymer and radical initiator but using TAIC as the sole curing co-agent

In the aspect in which the first curing co-agent includes cyanurates and isocyanurates, examples include, tri(methyl)allyl isocyanurate, triallyl isocyanurate, trimethallyl cyanurate, poly-triallyl isocyanurate, xylene-bis(diallyl isocyanurate), N,N′-m-phenylene bismaleimide, diallyl phthalate, tris(diallylamine)-2-triazine, triallyl phosphite, 1,2-polybutadiene, ethyleneglycol diacrylate, diethyleneglycol diacrylate, and combinations thereof.

In another aspect, in which the first curing co-agents are given by the formula CH₂═CH—R_{f}—CH═CH₂, R_{f} is selected from a divalent perfluoroaliphatic group optionally containing one or more o atoms, a perfluoroarylene group, and a perfluoroalkarylene group. Examples include, for instance, 1,6-divinylperfluorhexane, and 1,8-divinylperfluorooctane.

Second curing co-agents also include either trivinylcyclohexane, triallylcyclohexane, and derivatives thereof. By “derivatives” in this context is meant second curing co-agents having a cyclohexane structure that are substituted with at least one group selected from those having the general formula —CA=CB₂ and —CA₂CB=CG₂. In this context each A, B, and G may independently be selected from a hydrogen atom, a halogen, an alkyl group, an aryl group, and an alkaryl group, the latter three of which may be non-fluorinated, partially fluorinated, or perfluorinated. In addition, when the first curing co-agent is selected from the group of an allyl cyanurate, an allyl isocyanurate, a methallyl cyanurate, and a methallyl isocyanurate, then the second curing co-agent may be represented by the formula CH₂═CH—R_{f}—CH═CH₂, wherein R_{f} is selected from a divalent perfluoroaliphatic group optionally containing one or more O atoms, a perfluoroarylene group, and a perfluoroalkarylene group. Also, when the first curing co-agent is represented by the formula CH₂═CH—R_{f}—CH═CH₂, wherein R_{f} is selected from a divalent perfluoroaliphatic group optionally containing one or more O atoms, a perfluoroarylene group, and a perfluoroalkarylene group, the second curing co-agent may be selected from the group of an allyl cyanurate, an allyl isocyanurate, a methallyl cyanurate, and a methallyl isocyanurate.

First curing co-agents may generally be used in any amount. In some embodiments it is useful to include a first and second curing co-agent in an amount of 1 to 10 parts, particularly 1 to 5 parts per 100 parts of the fluorocarbon polymer.

The compositions may also include fillers that may improve the general physical properties (e.g., elongation and compression set) of the cured fluoroelastomers. The fillers are included in about 10 parts per 100 parts of the fluorocarbon polymer. Non-limiting examples of fillers include carbon blacks, graphites, conventionally recognized thermoplastic fluoropolymer micropowders, clay, silica, talc, diatomaceous earth, barium sulfate, wollastonite, calcium carbonate, calcium fluoride, titanium oxide, and iron oxide. Combinations of these fillers may also be employed. Those skilled in the art are capable of selecting specific fillers at amounts in the noted range to achieve desired physical characteristics in a cured elastomer.

Other materials may be incorporated into the composition to further enhance the physical properties (e.g., elongation and compression set) of the composition. For example, acid acceptors may be employed to facilitate the cure and thermal stability of the compound. Suitable acid acceptors may include, for instance, magnesium oxide, lead oxide, calcium oxide, calcium hydroxide, dibasic lead phosphate, zinc oxide, barium carbonate, strontium hydroxide, calcium carbonate, hydrotalcite, alkali stearates, magnesium oxalate, or combinations thereof. The acid acceptors may be used in amounts ranging from about 1 to about 25 parts per 100 parts by weight of the polymer. In another aspect, however, such acid acceptors are not necessary and their exclusion may allow the formation of so-called clear elastomers.

Fluorocarbon polymers useful in the compositions described herein include, for instance, those that may be cured to prepare a fluoroelastomer. The fluorocarbon polymer and hence the fluoroelastomer prepared therefrom, may be partially fluorinated or may be perfluorinated. The fluorocarbon polymer may also, in some aspects, be post-fluorinated. Monomers useful as constituent units of the fluorocarbon polymers include, for instance, vinylidene fluoride, tetrafluoroethylene, hexafluoropropylene, vinyl ether (e.g., perfluoro(methyl vinyl) ether), chlorotrifluoroethylene, pentafluoropropylene, vinyl fluoride, propylene, ethylene, and combinations thereof.

When a fluorinated vinyl ether is used, the fluorinated vinyl ether may be a perfluoro(vinyl) ether. In some embodiments, the perfluoro(vinyl) ether is selected from CF₂═CFO-[D]ₓ-R_{f} wherein each D is independently selected from —(CF₂)_{z}—, —O(CF₂)_{z}—, —O(CF(CF₃)CF₂)—, and —CF₂CF(CF₃)—, each z is independently 1 to 10, x is 0 to 10, and R_{f} is a linear or branched perfluoroalkyl having 1 to 10 carbon atoms. Examples include, for instance, CF₂═CFOCF₂OCF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂OCF₂CF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃,CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFCF₂OCF₂CF₂OCF₃, CF₂═CFOCF₂CF₂OCF₂OCF₂OCF₃, CF₂═CFOCF₂CF₂OCF₂CF₂CF₃,CF₂═CFOCF₂CF₂OCF₂CF₂OCF₂CF₂CF₃, CF₂═CFCF₂OCF₂CF₂OCF₃, CF₂═CFCF₂OCF₂OCF₃, CF₂═CFOCF₂CF₂CF₃, CF₂═CFOCF(CF₃)CF₂CF₃, CF₂═CFOCF₃, CF₂═CFOCF₂CF₃, and combinations thereof.

In another aspect, the fluorocarbon polymers described herein may comprise a cure site monomer. Cure site monomers allow for the preparation of an elastomer by curing the fluorocarbon polymer. When included, the cure site monomer may, for instance, be selected from one or more compounds of the formula: (IV) CX₂═CX(Z). In this formula, each X may be independently selected from H and F; and Z may be selected from Br, I, Cl, and R′_{f}U. In this context, U may be selected from Br, I, Cl, and CN and R′_{f} is a perfluorinated divalent linking group optionally containing one or more O atom(s). The cure site monomer also may, for instance, be selected from one or more compounds of the formula: (V) Y(CF₂)_{q}Y. In this formula, each Y may be selected from Br, I and Cl, and q is 1 to 6. In either of these aspects, Z and Y may be chemically bound to chain ends of the fluorocarbon polymer. Examples of cure site monomers useful in the presently described fluorocarbon polymers include, for instance, 1-bromo-1,1,2,2-tetrafluoro-3-butene, bromotetrafluoroethylene, 1-bromo-2,2-difluoroethylene, and CF₂═CFO(CF₂)₅CN (MV5CN).

The polymers described herein may be prepared using batch or semi-batch, or continuous emulsion polymerization processes. They may also be prepared by suspension or solution polymerization processes. These include, for instance, free-radical polymerization.

In another aspect, the compositions described herein may include a radical initiator. The radical initiator may include, for instance, a peroxide. Useful peroxides include organic and inorganic peroxides. When organic peroxides are used, they may further be chosen from those that do not decompose at dynamic mixing temperatures. Suitable radical initiators include, for instance, dicumyl peroxide, 2,5-dimethyl-2,5-di(t-butylperoxy)hexane, di-t-butyl peroxide, t-butylperoxy benzoate, t-butylperoxy-diisopropyl benzene, 2,5-dimethyl-2,5-di(t-butylperoxy)hexyne-3, lauryl peroxide, and combinations thereof. The radical initiator is any compound capable of initiating the curing reaction by generation of free radical species.

In yet another aspect, the present description relates to a method for preparing an elastomer comprising curing the compositions described herein to give an elastomer (cured material).

In preparing a composition for curing, the composition can be compounded with the curing co-agent(s) or mixed in one or several steps, using any of the usual rubber mixing devices such as internal mixers (e.g., Banbury mixers), roll mills, etc. For best results, the temperature of mixing should not rise above the temperature of initiation of a curing reaction. One of ordinary skill in the art is capable of determining this temperature based upon the radical initiator chosen, the curing co-agent(s) present, the fluorocarbon polymer, and the like. In some embodiments, the components may be distributed uniformly throughout the composition. This may help to provide a more effective cure.

In one aspect, curing may be accomplished through press curing compositions described herein. Pressing the composition (i.e., press cure) may typically be conducted at a temperature of about 95-230° C., particularly from about 150-205° C., for a period of about 1 minute to about 15 hours, usually from about 1 to 10 minutes. In this aspect, the process comprises providing the composition in a mold and heating the mold. The process further comprises pressing the composition (that is, applying pressure) at a pressure of about 700 to 20,000 kPa, particularly 3,400 to 6,800 kPa. The process may further comprise first coating the mold with a release agent and pre-baking the mold. Pre-baking, in this sense, refers to heating the mold before adding the composition. The mold may be returned to room temperature before adding the composition. In another aspect, the first curing co-agents described herein may aid in providing release from a mold. In this respect, press curing the compositions described herein may not require a first coating of release agent.

The process may further comprise post-curing the elastomer obtained by curing the composition as described herein. Post curing may take place in an oven at a temperature of about 150 to 315° C., more particularly at about 200 to 260° C., for a period of about 2 to 50 hours or more, depending on the cross-sectional thickness of the sample. For thicker samples, the temperature during the post cure may be raised gradually from the lower end of a range to a desired maximum temperature. The maximum temperature, for instance, 260° C., may then be held for about 4 hours or more.

The present description also provides a reaction product of a fluorocarbon polymer, a radical initiator, a first curing co-agent, and optionally a second curing co-agent. The first curing co-agent in one aspect may be selected from the group consisting of an allyl cyanurate, an allyl isocyanurate, a methallyl cyanurate, and a methallyl isocyanurate. In another aspect, the first curing co-agent is represented by the formula CH₂═CH—R_{f}—CH═CH₂. R_{f} is selected from a divalent perfluoroaliphatic group optionally containing one or more O atoms, a perfluoroarylene group, and a perfluoroalkarylene group. In either aspect, a second curing co-agent may be provided with the proviso that the second curing co-agent is not a member of the group of first curing co-agents. In one aspect, the reaction product is an elastomer.

The reaction product may be processed and provided as a shaped article, for example, by extrusion (for instance in the shape of a hose or a hose lining) or molding (for instance, in the form of an O-ring seal). The composition can be heated to cure the composition and form a cured, shaped elastomer article.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

These abbreviations are used in the following examples: wt=weight, min=minutes, mol=mole; phr=parts per hundred parts of rubber, hr=hour, ° C.=degrees Celsius, psi=pounds per square inch, MPa=megapascals, and N-m=Newton-meter.

The following abbreviations are used throughout the Examples:

| ABBREVIATION | DESCRIPTION |
|---|---|
| TFE | tetrafluoroethylene |
| HFP | hexafluoropropylene |
| VDF | vinylidenefluoride |
| BTFE | bromotetrafluoroethylene |
| PMVE | perfluoro(methyl vinyl ether) |
| MV5CN | CF₂═CFO(CF₂)₅CN |
| PEROXIDE1 | 2,5-dimethyl-2,5-di(t-butylperoxy)hexane |
| | on a silica filler. Peroxide crosslinker |
| | available under the trade designation |
| | “TRIGONOX 101-50D-pd” from Akzo |
| | Nobel, Arnhem, Netherlands |
| TAIC 72% | 72% triallylisocyanurate coagent known |
| | under the trade designation “TAIC DLC” |
| | available from Natrochem, Inc., Savannah, |
| | GA |
| TVC | Trivinylcyclohexane |
| DVPH | 1,6 divinylperfluorohexane available from |
| | Apollo Scientific Limited |
| | Derbyshire, United Kingdom |
| DVPO | 1,6 divinylperfluorooctane available from |
| | Apollo Scientific Limited |
| | Derbyshire, United Kingdom |
| OD | 1,7 octadiene, available from Sigma |
| | Aldrich NV/SA, Bornem Belgium |
| VC | Vinylcyclohexane, available from Sigma |
| | Aldrich NV/SA, Bornem Belgium |
| ABE | Allylbutylether, available from Sigma |
| | Aldrich NV/SA, Bornem Belgium |
| Fluoropolymer A | Copolymer of 17.0 wt % TFE, 28.8 wt % |
| | VDF, 53.9 wt % MV31, and 0.3 wt % |
| | BTFE |
| Fluoropolymer B | Copolymer of 55.0 wt % TFE, 44.2 wt % |
| | PMVE, and 0.8 wt % BTFE |
| Fluoropolymer C | Copolymer of 29.5 wt % TFE, 31.2 wt % |
| | HFP, 8.5 wt % VDF, and 0.6 wt % BTFE |
| Fluoropolymer D | Copolymer of 48.7 wt % TFE, 47.6 wt % |
| | PMVE and 3.7 wt % MV5CN |
| MB | Catalyst Masterbatch |
| | 20 wt % bistetrabutylphosphonium |
| | perfluoroadipate in Fluoropolymer D |
| R972 | Silica available under the trade designation |
| | “AEROSIL R972” from Degussa AG, |
| | Düsseldorf, Germany |
| N550 | Carbon black available under the trade |
| | designation “FEF-N550” from Cabot |
| | Corp., Atlanta, GA |
| ZnO | ZnO, available from Bayer AG, |
| | Leverkusen, Germany |
| Carnauba wax | Carnauba wax available from Taber Inc., |
| | Barrington, RI |

### Examples 1-11 and Comparative Examples 1-9

Fluoropolymer was compounded on a two roll mill with the addition of additives as indicated in Table 1. The compounded mixture was press-cured at various temperatures and times as indicated in Table 1. Subsequently the molded test sheets and O-rings were post-cured in air at various temperatures and times as indicated in Table 1.

After press-cure and post-cure, physical properties were measured with dumbbells cut from a post-cured test slab.

In comparing the results reported herein, it may be useful to make the following comparisons:

| Fluoropolymer | Example | Comparative Example |
|---|---|---|
| Fluoropolymer A | Example 1 (TAIC and TVC) | CE1 (TAIC only) |
| | | CE2 (TVC only) |
| | | CE8 (DVPH only) |
| Fluoropolymer B | Example 2 (TAIC and TVC) | CE3 (TAIC only) |
| | | CE4 (TVC only) |
| Fluoropolymer C | Example 3 (TAIC and TVC) | CE5 (TAIC only) |
| | | CE6 (TVC only) |
| Fluoropolymer C | Example 5 (DVPO and TAIC) | CE5 (TAIC only) |
| | | CE9 (DVPH only) |
| Fluoropolymer C | Example 6 (DVPO and TVC) | CE6 (TVC only) |
| | | CE9 (DVPH only) |
| Fluoropolymer C | Example 9 (TAIC and OD) | CE5 (TAIC only) |
| | Example 10 (TAIC and ABE) | |
| | Example 11 (TAIC and VC) | |
| Fluoropolymer D | Example 4 (TAIC and TVC) | CE 7 (TAIC only) |
| | Example 7 (TAIC and DVPO) | |

TABLE 1
FORMULATIONS

| COMPONENT | | | | | | | | | | | |
|---|---|---|---|---|---|---|---|---|---|---|---|
| phr | CE1 | EX1 | CE2 | CE3 | EX2 | CE4 | CE5 | EX3 | CE6 | CE7 | EX4 |
| Fluoropolymer A | 100 | 100 | 100 | — | — | — | — | — | — | — | — |
| Fluoropolymer B | — | — | — | 100 | 100 | 100 | — | — | — | — | — |
| Fluoropolymer C | — | — | — | — | — | — | 100 | 100 | 100 | — | — |
| Fluoropolymer D | — | — | — | — | — | — | — | — | — | 96 | 96 |
| MB | — | — | — | — | — | — | — | — | — | 5.0 | 5.0 |
| PEROXIDE1 | 4.0 | 4.0 | 4.0 | 2.5 | 2.5 | 4.0 | 4.0 | 4.0 | 4.0 | 1.4 | 1.4 |
| TAIC 72% | 3.0 | 1.4 | — | 2.5 | 1.3 | — | 3.5 | 2.1 | — | 1.8 | 0.7 |
| TVC | — | 1.0 | 3.0 | — | 0.9 | 3.0 | — | 1.0 | 3.0 | — | 0.8 |
| R972 | — | — | — | — | — | — | — | — | — | 1.0 | 1.0 |
| N550 | 10.0 | 10.0 | 20.0 | 10.0 | 10.0 | 20.0 | 10.0 | 10.0 | 20.0 | 10.0 | 10.0 |
| ZnO | 3.0 | 3.0 | 3.0 | 3.0 | 3.0 | 3.0 | 3.0 | 3.0 | 3.0 | — | — |
| Carnauba Wax | 0.5 | 0.5 | 0.5 | 0.5 | 0.5 | 0.5 | 0.5 | 0.5 | 0.5 | 0.5 | 0.5 |

| COMPONENT | | | | | | | | EX | EX |
|---|---|---|---|---|---|---|---|---|---|
| phr | CE8 | EX5 | EX6 | CE9 | EX7 | EX8 | EX9 | 10 | 11 |
| Fluoropolymer A | 100 | — | — | — | — | — | — | — | — |
| Fluoropolymer C | — | 100 | 100 | 100 | — | — | 100 | 100 | 100 |
| Fluoropolymer D | — | — | — | — | 96 | 96 | — | — | — |
| MB | — | — | — | — | 5.0 | 5.0 | — | — | — |
| PEROXIDE1 | 4.0 | 4.0 | 4.0 | 4.0 | 1.4 | 1.4 | 4.0 | 4.0 | 4.0 |
| TAIC 72% | — | 2.1 | — | — | 0.7 | — | 1.8 | 1.8 | 1.8 |
| OD | — | — | — | — | — | — | 1.3 | — | — |
| ABE | — | — | — | — | — | — | — | 1.3 | — |
| VC | — | — | — | — | — | — | — | — | 1.3 |
| TVC | — | — | 1.5 | — | — | 0.7 | — | — | — |
| DVPO | — | 1.0 | 1.0 | — | 0.8 | 0.8 | — | — | — |
| DVPH | 2.1 | — | — | 2.1 | — | — | — | — | — |
| R972 | — | — | — | — | 1.0 | 1.0 | — | — | — |
| N550 | 20. | 10. | 10. | 20. | 10. | 10. | 10. | 10. | 10. |
| ZnO | 3.0 | 3.0 | 3.0 | 3.0 | — | — | 3.0 | 3.0 | 3.0 |
| Carnauba Wax | 0.5 | 0.5 | 0.5 | 0.5 | 0.5 | 0.5 | 0.5 | 0.5 | 0.5 |

### Results

Rheology, physical properties and compression set are shown in Tables 2-4.

Cure rheology tests were carried out using uncured, compounded samples using a rheometer marketed under the trade designation Monsanto Moving Die Rheometer (MDR) Model 2000 by Monsanto Company, Saint Louis, Mo., in accordance with ASTM D 5289-93a at 177° C., no pre-heat, 30 minute elapsed time, and a 0.5 degree arc. Both the minimum torque (M_{L}) and highest torque attained during a specified period of time when no plateau or maximum torque was obtained (M_{H}) were measured. Also measured were the time for the torque to increase 2 units above M_{L} (t_{S}2), the time for the torque to reach a value equal to M_{L}+0.5(M_{H}−M_{L}), (t′50), and the time for the torque to reach M_{L}+0.9(M_{H}−M_{L}), (t′90). Results are reported in Table 2 (below).

TABLE 2
RHEOLOGY

| | CE1 | EX1 | CE2 | CE3 | EX2 | CE4 | CE5 | EX3 | CE6 | CE7 | EX4 |
|---|---|---|---|---|---|---|---|---|---|---|---|
| min | 6 | 6 | 6 | 6 | 6 | 6 | 6 | 6 | 6 | 6 | 6 |
| ° C. | 177 | 177 | 177 | 177 | 177 | 177 | 177 | 177 | 177 | 177 | 177 |
| M_{L}, in-lb | 2.4 | 2.1 | 2.8 | 2.8 | 2.5 | 2.7 | 1.0 | 0.8 | 1.0 | 1.1 | 1.0 |
| (N-m) | | | | | | | | | | | |
| M_{H}, in-lb | 7.7 | 8.2 | 7.5 | 15.0 | 14.5 | 11.1 | 14.6 | 16.2 | 11.9 | 7.1 | 9.2 |
| (N-m) | | | | | | | | | | | |
| t_{S}2, min | 0.64 | 1.05 | 2.34 | 0.49 | 0.70 | 0.72 | 0.53 | 0.82 | 1.21 | 0.91 | 1.47 |
| t′50, min | 0.712 | 1.40 | 2.66 | 0.65 | 1.22 | 1.39 | 0.69 | 1.61 | 2.34 | 1.20 | 2.48 |
| t′90, min | 1.35 | 3.53 | 5.09 | 1.39 | 3.65 | 4.70 | 1.37 | 3.97 | 4.79 | 4.01 | 4.98 |

| | CE8 | EX5 | EX6 | CE9 | EX7 | EX8 | EX9 | EX10 | EX11 |
|---|---|---|---|---|---|---|---|---|---|
| min | 6 | 6 | 6 | 6 | 6 | 6 | 6 | 6 | 6 |
| ° C. | 177 | 177 | 177 | 177 | 177 | 177 | 177 | 177 | 177 |
| M_{L}, in-lb | 1.8 | 0.8 | 0.6 | 0.8 | 0.9 | 1.0 | 0.8 | 0.8 | 0.8 |
| (N-m) | | | | | | | | | |
| M_{H}, in-lb | 4.5 | 11.7 | 11.7 | 10.0 | 5.8 | 7.4 | 12.7 | 10.9 | 10.5 |
| (N-m) | | | | | | | | | |
| t_{S}2, min | 2.75 | 0.59 | 1.10 | 1.35 | 1.39 | 1.68 | 0.69 | 0.66 | 0.61 |
| t′50, min | 2.01 | 0.78 | 1.89 | 2.06 | 1.68 | 2.43 | 1.06 | 0.87 | 0.81 |
| t′90, min | 3.84 | 1.82 | 4.20 | 4.03 | 4.12 | 4.94 | 2.63 | 1.69 | 2.06 |

Press-cured sheets (150 mm×150 mm×2.0 mm) of the curable compositions prepared in Examples 1-11 and Comparative Examples 1-9, except where indicated in Tables 3 and 4, were prepared for physical property determination by pressing the compostion at various temperatures and times as detailed in Table 3. Press-cured sheets were post-cured by exposure to heat under various temperatures and times detailed in Table 3. All specimens were returned to ambient temperature before testing.

Physical Properties

Tensile strength at break, elongation at break, and modulus at 100% elongation were determined according to ASTM D 412-92 using samples cut from the corresponding specimen using ASTM Die D.

Hardness was measured using ASTM D 2240-85 Method A with a Type A-2 Shore Durometer.

Table 3 (below) reports physical properties of the press-cured and post-cured sheets of the curable compositions of Examples 1 - 11 and Comparative Examples 1-9, except where indicated.

TABLE 3
PHYSICAL PROPERTIES

| | CE1 | EX1 | CE2 | CE3 | EX2 | CE4 | CE5 | EX3 | CE6 | CE7 | EX4 |
|---|---|---|---|---|---|---|---|---|---|---|---|
| Press cure | 7 | 7 | 7 | 7 | 7 | 7 | 7 | 7 | 7 | 7 | 7 |
| min | | | | | | | | | | | |
| Press cure | 177 | 177 | 177 | 177 | 177 | 177 | 177 | 177 | 177 | 177 | 177 |
| ° C. | | | | | | | | | | | |
| Post cure | 16 | 16 | 16 | 16 | 16 | 16 | 16 | 16 | 16 | 16 | 16 |
| hr | | | | | | | | | | | |
| Post cure | 230 | 230 | 230 | 230 | 230 | 230 | 230 | 230 | 230 | 230 | 230 |
| ° C. | | | | | | | | | | | |
| Tensile | B | (8.7) | (10.9) | (18.2) | (19.2) | (18.3) | (18.9) | (19.8) | (22.8) | (13.9) | (14.1) |
| Strength at | | 1261 | 1581 | 2640 | 2785 | 2654 | 2741 | 2871 | 3307 | 2016 | 2045 |
| Break, | | | | | | | | | | | |
| (MPa) psi | | | | | | | | | | | |
| Elongation | B | 209 | 210 | 128 | 125 | 92 | 239 | 224 | 204 | 206 | 135 |
| at Break, % | | | | | | | | | | | |
| 100% | B | (2.1) | (3.6) | (12.5) | (12.7) | No | (4.4) | (4.6) | (8.2) | (6.3) | (9.3) |
| Modulus, | | 305 | 522 | 1813 | 1842 | data | 638 | 667 | 1189 | 914 | 1349 |
| (MPa) psi | | | | | | | | | | | |
| Shore A | B | 55 | 68 | 73 | 73 | 84 | 74 | 73 | 81 | 75 | 78 |
| Hardness | | | | | | | | | | | |

| | CE8 | EX5 | EX6 | CE9 | EX7 | EX8 | EX9 | EX10 | EX11 |
|---|---|---|---|---|---|---|---|---|---|
| Press cure | 7 | 7 | 7 | 7 | 7 | 7 | 7 | 7 | 7 |
| min | | | | | | | | | |
| Press cure | 177 | 177 | 177 | 177 | 177 | 177 | 177 | 177 | 177 |
| ° C. | | | | | | | | | |
| Post cure | 16 | 16 | 16 | 16 | 16 | 16 | 16 | 16 | 16 |
| hr | | | | | | | | | |
| Post cure | 230 | 230 | 230 | 230 | 230 | 230 | 230 | 230 | 230 |
| ° C. | | | | | | | | | |
| Tensile | No | (17.4) | (17.9) | (20.4) | (9.1) | (15.0) | (17.4) | No | (21.2) |
| Strength at | data | 2524 | 2596 | 2959 | 1320 | 2176 | 2524 | data | 3075 |
| Break, | | | | | | | | | |
| (MPa) psi | | | | | | | | | |
| Elongation | No | 274 | 249 | 337 | 152 | 198 | 227 | No | 277 |
| at Break, % | data | | | | | | | data | |
| 100% | No | (2.8) | (3.2) | (3.4) | (4.6) | (6.2) | (4.3) | No | (3.1) |
| Modulus, | data | 406 | 464 | 493 | 667 | 899 | 624 | data | 450 |
| (MPa) psi | | | | | | | | | |
| Shore A | No | 68 | 68 | 74 | 71 | 74 | 70 | No | 67 |
| Hardness | data | | | | | | | data | |

In Table 3 above, “No data” indicates that plates were not made in a way so as to be able to measure properties.

Specimens of the curable compositions of Examples 1-9 and Comparative Examples 1-9, except where indicated in Table 4, were press-cured and post-cured to form buttons having a thickness of 0.24 inches (6 mm). Compression set of button specimens was measured using ASTM 395-89 Method B. Results are reported in Table 4 (below) as a percentage of permanent set, and were measured at 25% deflection.

TABLE 4
COMPRESSION SET

| | CE1 | EX1 | CE2 | CE3 | EX2 | CE4 | CE5 | EX3 | CE6 | CE7 | EX4 |
|---|---|---|---|---|---|---|---|---|---|---|---|
| hr | 70 | 70 | 70 | 70 | 70 | 70 | 70 | 70 | 70 | 70 | 70 |
| ° C. | 200 | 200 | 200 | 200 | 200 | 200 | 200 | 200 | 200 | 200 | 200 |
| Compression | 27 | 29 | 46 | 37 | 31 | 51 | 29 | 24 | 33 | 41 | 31 |
| set % | | | | | | | | | | | |

| | CE8 | EX5 | EX6 | CE9 | EX7 | EX8 | EX9 | EX10 | EX11 |
|---|---|---|---|---|---|---|---|---|---|
| hr | 70 | 70 | 70 | 70 | 70 | 70 | 70 | 70 | 70 |
| ° C. | 200 | 200 | 200 | 200 | 200 | 200 | 200 | 200 | 200 |
| Compression | No | 41 | 40 | No | 40 | 30 | 31 | 33 | 34 |
| set % | data | | | data | | | | | |

In Table 4 above, “No data” indicates that compression sets were not measured.

Various modifications and alterations of this invention may be made by those skilled in the art without departing from the scope and spirit of this invention, and it should be understood that this invention is not to be unduly limited to the illustrative embodiments set forth herein.

What is claimed is:

1. A composition comprising:
a fluorocarbon polymer;
a radical initiator;
a first curing co-agent selected from the group consisting of an allyl cyanurate, an allyl isocyanurate, a methallyl cyanurate, and a methallyl isocyanurate; and
a second curing co-agent comprising an organic compound including at least one terminal alkene, with the proviso that the second curing co-agent is not a member of the group of first curing co-agents.

2. The composition of claim 1 wherein the first curing co-agent is selected from tri(methyl)allyl isocyanurate, triallyl isocyanurate, tri(methyl)allyl cyanurate, poly-triallyl isocyanurate, xylylene-bis(diallyl isocyanurate), and combinations thereof.

3. The composition of claim 1, wherein the second curing co-agent is selected from 1,3,5-trivinylcyclohexane, vinylcyclohexane, 1,6-divinylperfluorohexane, 1,8-divinylperfluorooctane, N,N′-m-phenylene bismaleimide, diallyl phthalate, tris(diallylamine)-2-triazine, triallyl phosphate, 1,2-polybutadiene, ethylene glycol diacrylate, diethyleneglycol diacrylate, and combinations thereof.

4. The composition of claim 1 wherein the radical initiator is an organic peroxide.

5. The composition of claim 4 wherein the organic peroxide is selected from dicumyl peroxide, 2,5-dimethyl-2,5-di(t-butylperoxy)hexane, di-t-butyl peroxide, t-butylperoxy benzoate, t-butylperoxy-diisopropyl benzene, 2,5-dimethyl,2,5-di(t-butylperoxy)hexyne-3, lauryl peroxide, and combinations thereof.

6. The composition of claim 1 wherein the fluorocarbon polymer comprises units derived from a cure site monomer.

7. The composition of claim 6 wherein the cure site monomer is selected from:
one or more compounds of the formula CX₂═CX(Z), wherein each X is selected from H and F; and Z is selected from Br, I, Cl, and R′_{f}U, wherein U is selected from Br, I, Cl, and CN and R′_{f} is a perfluorinated divalent linking group optionally containing one or more O atom(s); and
one or more compounds of the formula Y(CF₂)_{q}Y, wherein Y is selected from Br, I, and Cl, and q is 1 to 6.

8. The composition of claim 7 wherein Z and Y are chemically bound to chain ends of the fluorocarbon polymer.

9. The composition of claim 1 wherein the fluorocarbon polymer is perfluorinated.

10. The composition of claim 1 wherein the fluorocarbon polymer is partially fluorinated.

11. The composition of claim 1 wherein the fluorocarbon polymer comprises units derived from monomers selected from vinylidene fluoride, tetrafluoroethylene, hexafluoropropylene, vinyl ether, and chlorotrifluoroethylene.

12. The composition of claim 11 wherein the vinyl ether is a perfluoro(vinyl) ether.

13. The composition of claim 12 wherein the perfluoro(vinyl) ether is selected from ethers having the general formula CF₂═CFO-[D]ₓ-R_{f}, wherein each D is independently selected from —(CF₂)_{z}—, —O(CF₂)_{z}—, —O(CF(CF₃)CF₂)—, and —CF₂CF(CF₃)—, each z is independently 1 to 10, x is 0 to 10, and R_{f} is a linear or branched perfluoroalkyl having 1 to 10 carbon atoms.

14. The composition of claim 1 wherein the composition has a t′50 that is 10% longer or more, than compositions that a composition comprising the same fluorocarbon polymer and radical initiator but using TAIC as the sole curing co-agent.

15. The composition of claim 1 wherein the composition has a t′90 that is 10% longer or more, than compositions that a composition comprising the same fluorocarbon polymer and radical initiator but using TAIC as the sole curing co-agent.

16. A method of forming an elastomer comprising curing the composition of claim 1.

17. The reaction product formed by the reaction of the fluorocarbon polymer, radical initiator, first curing co-agent, and second curing co-agent of claim 1.

18. A composition comprising:
a fluorocarbon polymer;
a radical initiator;
a first curing co-agent represented by the formula CH₂═CH—R_{f}—CH═CH₂ wherein R_{f} is selected from a divalent perfluoroaliphatic group optionally containing one or more O atoms, a perfluoroarylene group, and a perfluoroalkarylene group; and
a second curing co-agent comprising an organic compound including at least one terminal alkene, with the proviso that the second curing co-agent is not a member of the group of first curing co-agents.
